(19) United States
(12) Patent Application Publication
(10) Pub. No.: US 2003/0183285 A1
(43) Pub. Date: Oct. 2, 2003

(54) Water control valve device having check valve

(76) Inventor: Tsai Chen Yang, Taichung (TW)

Correspondence Address: Tsai Chen YANG, P.O. Box 63-99, Taichung, 406, TW

(21) Appl. No.: 10/106,448

(22) Filed: Mar. 27, 2002

(51) Int. Cl. F16K 11/074

(52) U.S. Cl. 137/625.17

(57) ABSTRACT

A water control valve device includes a housing having one or more inlet orifices and greater openings for receiving water, and one or more check valves each having an inner casing engaged into the inlet orifice of the housing and an outer peripheral flange engaged in the opening of the housing, and each having a port for receiving water. The check valve includes one or more inclined surfaces for forming a closable and openable mouth which is openable when water flows into the casing and which may be closed for preventing the water from flowing out of the housing.

### BACKGROUND OF THE INVENTION

1. Field of the Invention

The present invention relates to a water control valve device, and more particularly to a water control valve device for mixing cold and hot water and having check valves for preventing the water from backward flowing.

2. Description of the Prior Art

Various kinds of typical water control valve devices have been developed for controlling the flowing of the water, such as for controlling the mixing and the flowing of the water. FIG. 1 illustrates one of the typical water control valve devices including a valve housing body 10 having one or more water inlet openings 11, 12 formed therein for receiving such as the cold water and/or the hot water.

One or more check valves are provided and engaged into the water inlet openings 11, 12, and each includes a casing 13 for engaging into the water inlet openings 11, 12 of the valve housing body 10. The casing 13 includes a stud 14 and one or more orifices 17 formed and provided in the inner end thereof that is engaged within the water inlet openings 11, 12 of the valve housing body 10.

A plug 18 is coupled to the stud 14 with a spring 15 which may bias the plug 18 against a valve seat 19 for allowing the water to flow into and through the check valve casing 13 only and for preventing the water from flow out through the check valve casing 13. A sealing ring 16 is further required to be provided and engaged onto the outer peripheral portion of the casing 13 for making a water tight seal with a cover (not shown) that will be secured onto the housing body 10.

However, the check valves include a spring 15 and a plug 18 that may not be easily engaged and assembled into the casing 13, such that the manufacturing speed of the check valves is greatly decreased. In addition, the spring 15 is typically made of metal materials that may be easily rusted after use.

The present invention has arisen to mitigate and/or obviate the afore-described disadvantages of the conventional water control valve devices.

### SUMMARY OF THE INVENTION

The primary objective of the present invention is to provide a water control valve device including check valves for preventing the water from backward flowing.

The other objective of the present invention is to provide a water control valve device including a configuration that may be easily manufactured and assembled.

In accordance with one aspect of the invention, there is provided a water control valve device comprising a housing including at least one inlet orifice formed therein, and including an outer portion having an opening formed therein and communicating with the inlet orifice of the housing, the opening of the housing including an inner diameter greater than that of the inlet orifice of the housing for forming a peripheral shoulder between the opening and the inlet orifice of the housing, and a check valve including an inner portion having a casing provided therein for engaging into the inlet orifice of the housing, and including an outer portion having a peripheral flange extended radially outward from the casing for engaging in the opening of the housing, and including a port formed in the outer portion of the check valve for allowing water to flow into the casing of the check valve. The check valve includes at least one inclined surface inclined inward the housing for forming a closable and openable mouth in the inner portion, the mouth is openable when water flows into the casing via the port of the check valve, and the mouth is closable when the water does not flow through the port of the check valve, in order to prevent the water from flowing backward and outward of the check valve.

The housing includes a peripheral rib extended inward of the opening of the housing, the peripheral flange of the check valve includes a peripheral groove formed therein for receiving the peripheral rib of the housing and for solidly securing the check valve to the housing.

The peripheral flange of the check valve includes an outer peripheral portion having one or more peripheral bulges extended outward therefrom and concentric with each other for forming as a sealing ring device.

The casing includes at least one swelling extended from the inclined surface of the housing for reinforcing the inclined surface of the housing.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a plane and partial exploded view of a typical water control valve device, in which a portion of the valve device is cut off for showing the inner structure of the valve device and of the check valve member;

FIG. 2 is a partial exploded view of a water control valve device in accordance with the present invention;

FIG. 3 is a plane and partial exploded view of the water control valve device in accordance with the present invention, in which a portion of the valve device is cut off for showing the inner structure of the valve device and of the check valve;

FIG. 4 is a partial plane view of the water control valve device, in which a portion of the valve device is cut off for showing the inner structure of the valve device and of the check valve;

FIG. 5 is a plane view of the check valve of the water control valve device; and

FIGS. 6 and 7 are perspective views illustrating the operation of the check valve of the water control valve device.

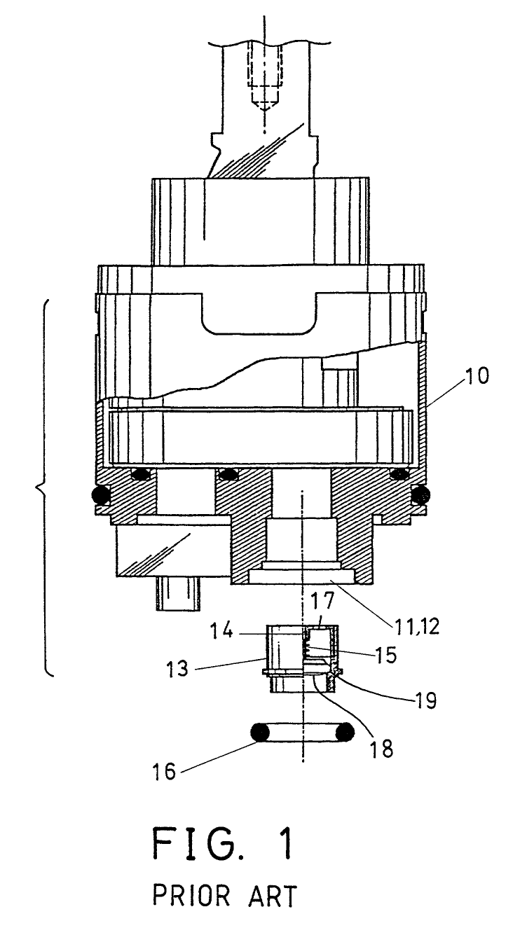

### DETAILED DESCRIPTION OF THE PREFERRED EMBODIMENT

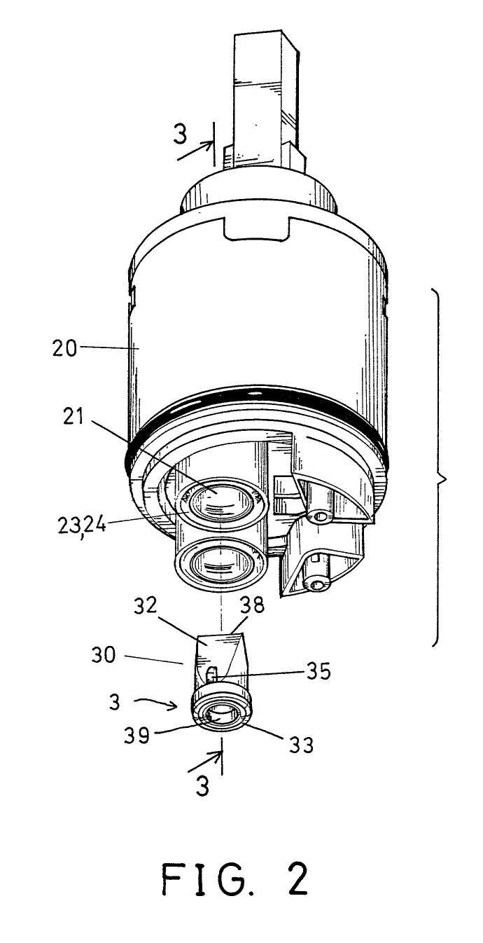

Referring to the drawings, and initially to FIGS. 2-5, a water control valve device in accordance with the present invention comprises a housing 20 having one or more water inlet orifices 21 formed therein for receiving such as the cold water and/or the hot water, and one or more openings 22 formed on the outer portion thereof and communicating with the inlet orifices 21 respectively. The openings 22 have an inner diameter greater than that of the inlet orifices 21 of the housing 20 for forming a peripheral shoulder between the openings 22 and the inlet orifices 21 of the housing 20. The housing 20 includes a peripheral rib 24 extended inward of the opening 22 from the peripheral shoulder 23 of the housing 20.

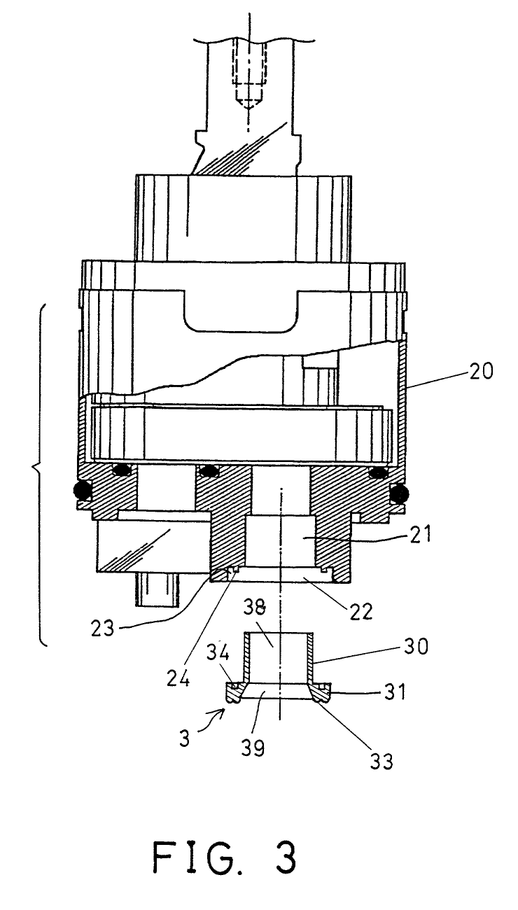

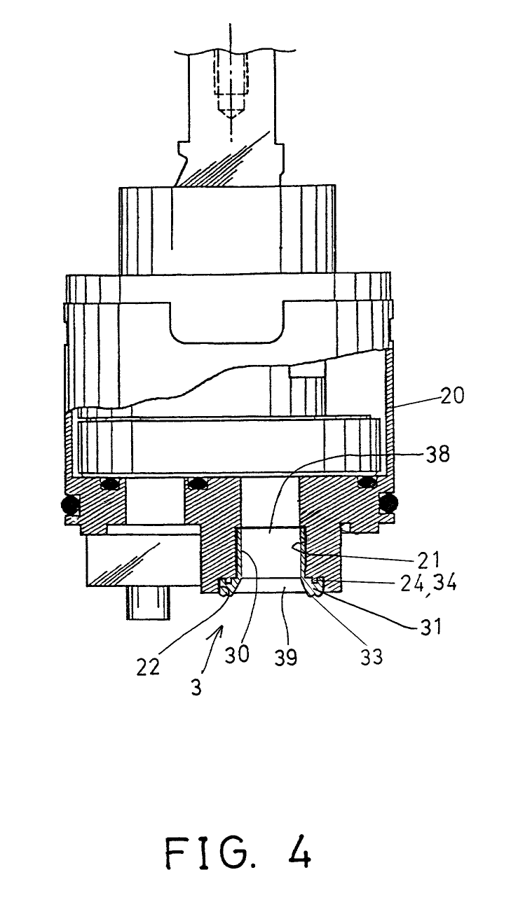

One or more check valves 3 are provided and engaged into the inlet orifices 21 respectively, and are preferably made of resilient materials, such as the rubber materials or the synthetic materials. The check valves 3 each includes a casing 30 for engaging into the inlet orifices 21 of the valve housing 20, and a peripheral flange 31 extended radially outward from one end, such as the outer end thereof for engaging into the opening 22 of the housing 20, best shown in FIGS. 3, 4. The peripheral flange 31 includes a peripheral groove 34 formed in the inner peripheral portion thereof for receiving the peripheral rib 24 of the housing 20, and for solidly securing the peripheral flange 31 of the check valve 3 to the housing 20.

The peripheral flange 31 further includes an outer peripheral portion having one or more peripheral bulges 33 formed therein for forming and acting as a sealing ring device, and for engaging with a typical cover (not shown) that will be secured onto the housing 20, and for making a water tight seal with the cover. The cover may engage with the peripheral flange 31 of the check valve 3 and thus may solidly secure the peripheral flange 31 of the check valve 3 between the housing 20 and the cover. It is preferable that the peripheral bulges 33 are concentric bulges. The engagement of the peripheral rib 24 of the housing 20 in the peripheral groove 34 of the peripheral flange 31 may further solidly secure and retain the peripheral flange 31 of the check valve 3 to the housing 20.

The casing 30 includes one or two inclined surfaces 32 formed and provided in the inner end thereof that is engaged within the inlet orifices 21 of the housing 20, having an inner end inclined inward or toward the inner portion of the housing 20, or having a free edge resiliently engaged with each other for forming a closable and openable mouth 38 in the inner end thereof. The casing 30 includes a port 39 formed in the outer end thereof or formed in the peripheral flange 31 for receiving water into and through the casing 30, and includes one or more swellings 35 extended from the inclined surfaces 32 thereof for reinforcing the inclined surfaces 32.

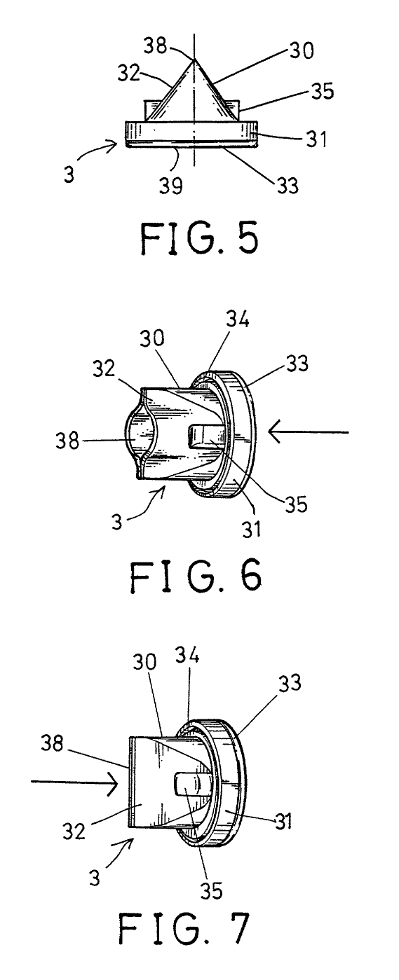

In operation, as shown in FIGS. 4 and 6, when water flows into the port 39 of the casing 30, the water flow or the pressure of the water may force and push the inclined surfaces 32 of the housing 30 away from each other for opening the mouth 38 of the casing 30 (FIG. 6) and for allowing the water to flow through the check valve 3 and to flow into the inlet orifice 21 of the housing 20.

As shown in FIG. 7, when the water is no longer supplied to the check valve 3 and does not flow into the port 39 of the casing 30, no water force or pressure may be applied to the casing 30 to push or move the inclined surfaces 32 of the housing 30 away from each other, such that the mouth 38 of the casing 30 will not be opened and will be closed by the resilience of the casing 30. The water may thus be prevented from flowing backward through the mouth 38 of the casing 30 and may thus be prevented from flowing out through the check valve 3.

It is to be noted that the check valve 3 itself includes a simplified configuration that may be easily and quickly manufactured with a molding or mold injection process without any further assembling processes. The check valve 3 may also be easily engaged into the inlet orifice 21 of the housing 20, and may be solidly secured to the housing 20.

Accordingly, the water control valve device in accordance with the present invention includes check valves for preventing the water from backward flowing, and includes a configuration that may be easily manufactured and assembled.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A water control valve device comprising:
a housing including at least one inlet orifice formed therein, and including an outer portion having an opening formed therein and communicating with said at least one inlet orifice of said housing, said opening of said housing including an inner diameter greater than that of said at least one inlet orifice of said housing for forming a peripheral shoulder between said opening and said at least one inlet orifice of said housing, and
a check valve including an inner portion having a casing provided therein for engaging into said at least one inlet orifice of said housing, and including an outer portion having a peripheral flange extended radially outward from said casing for engaging in said opening of said housing, and including a port formed in said outer portion of said check valve for allowing water to flow into said casing of said check valve,
said check valve including at least one inclined surface inclined inward said housing for forming a closable and openable mouth in said inner portion, said mouth being openable when water flows into said casing via said port of said check valve, and said mouth being closable when the water does not flow through said port of said check valve, in order to prevent the water from flowing backward and outward of said check valve.

2. The water control valve device according to claim 1, wherein said housing includes a peripheral rib extended inward of said opening of said housing, said peripheral flange of said check valve includes a peripheral groove formed therein for receiving said peripheral rib of said housing and for solidly securing said check valve to said housing.

3. The water control valve device according to claim 1, wherein said peripheral flange of said check valve includes an outer peripheral portion having at least one peripheral bulge extended outward therefrom for forming as a sealing ring.

4. The water control valve device according to claim 1, wherein said peripheral flange of said check valve includes an outer peripheral portion having at least two concentric peripheral bulge extended outward therefrom for forming as sealing rings.

5. The water control valve device according to claim 1, wherein said casing includes at least one swelling extended from said at least one inclined surface of said housing for reinforcing said at least one inclined surface of said housing.

6. A water control valve device comprising:
a housing including at least one inlet orifice formed therein, and including an outer portion having an opening formed therein and communicating with said at least one inlet orifice of said housing, said opening of said housing including an inner diameter greater than that of said at least one inlet orifice of said housing for forming a peripheral shoulder between said opening and said at least one inlet orifice of said housing, and
a check valve including an inner portion having a casing provided therein for engaging into said at least one inlet orifice of said housing, and including an outer portion having a peripheral flange extended radially outward from said casing for engaging in said opening of said housing, and including a port formed in said outer portion of said check valve for allowing water to flow into said casing of said check valve,
said check valve including a pair of inclined surfaces inclined inward said housing for forming a closable and openable mouth in said inner portion, said mouth being openable when water flows into said casing via said port of said check valve, and said mouth being closable when the water does not flow through said port of said check valve, in order to prevent the water from flowing backward and outward of said check valve.
